(19) United States
(12) Patent Application Publication
(10) Pub. No.: US 2009/0246618 A1
(43) Pub. Date: Oct. 1, 2009

(54) Insert molded electrode grid

(75) Inventor: Keith W. Dirks, Sterling, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Firefly Energy Inc.

(21) Appl. No.: 12/382,978

(22) Filed: Mar. 27, 2009

Related U.S. Application Data
(60) Provisional application No. 61/064,827, filed on Mar. 28, 2008.

(51) Int. Cl. H01M 2/02; H01M 4/66; H01M 4/72

(52) U.S. Cl. 429/163; 429/245; 429/241; 264/104; 264/105

(57) ABSTRACT

The present disclosure is directed to an electrode grid for a battery. The electrode grid may include at least one active material retaining segment, the active material retaining segment including one or more channels. The at least one active material retaining segment may be formed of at least one of carbon foam and graphite foam. In addition, the electrode grid may include a conductive material deposited within the one or more channels.

### PRIORITY

This application claims the benefit of priority of U.S. Provisional Patent Application No. 61/064,827, which was filed on Mar. 28, 2008.

### TECHNICAL FIELD

The present disclosure relates to the field of batteries. More particularly, the present disclosure relates to a structure and method of manufacture for positive and negative electrode grids.

### BACKGROUND

Storage and release of electrical energy in electro-chemical batteries may be enabled by chemical reactions that occur in a active material disposed on one or more electrode grids that at as current collectors within the battery. Once coated with the active material, the positive and negative grids are referred to as positive and negative plates, respectively.

Batteries may also include an electrolytic solution, and the composition of this solution may be chosen to correspond with a particular battery chemistry. For example, lead-acid batteries may include an acidic electrolytic solution. A variety of acids may be suitable for use as the electrolyte of a lead-acid battery. For example, sulfuric acid may be mixed with water to provide the electrolyte solution of a battery. Alternatively, batteries of other chemistries may include other electrolytes. For example, nickel-based batteries may include alkaline electrolyte solutions that include a base (e.g., KOH) mixed with water. Gel-electrolytes of a suitable chemistry may also be used.

Two methods for manufacturing electrode grids for lead-acid batteries include book molding and material calendaring/form cutting. Book molding may involve pouring molten lead into a desired pattern cut into a mold tool and then cooling the molten lead to enable hardening. Following hardening of the lead, the electrode grid may be removed from the mold. Material calendaring/form cutting involves producing a flat thin ribbon of lead that may be coiled onto a spool for later use or, in a continuous manufacturing operation, may go directly to a cutting station. At a cutting station, openings and an outer shape for a desired electrode may be created in portions of the ribbon. Following construction in both methods, an electrode may be coated with an active material such that the active material is disposed within the openings of the electrode formed during manufacture using either method.

In addition to providing conductivity in the role of a current collector, electrode grids utilized in lead-acid batteries may be configured to provide structural support to the active material. However, electrode grids manufactured through book molding and/or calendaring/form cutting may lack a desired strength or an ability to retain active paste material. Further, such grids may lack a desired amount of electrically conductive surface area.

Electrode grids have been developed to improve strength, reduce weight, and/or enhance conductivity. For example, U.S. Pat. No. 6,232,017 to Tsuchida et al. (“the '017 patent”) discloses a grid for a lead-acid battery, wherein the grid includes glass fiber sheets to provide strength while reducing weight. The '017 patent also includes electricity collecting parts that are simultaneously cast with the glass fiber sheets.

While the glass fiber sheets of the '017 patent may be both strong and lightweight, glass fiber sheets are not particularly well suited for providing structural support for longitudinal compressive forces. Further, while the electricity collecting parts may provide some electrical conductivity, the electricity collecting parts are cast as layers on top of the glass fiber sheets and, therefore, do not provide particularly compact packaging, nor does the combination of conductive material strips layered upon glass fiber sheets provide an even surface upon which an active material layer may be coated. Moreover, the glass fiber sheets are electrically insulating. Therefore, the glass fiber sheets likely do not collect current from the active material layer well, and thus, do not enhance, but rather inhibit, the current flow in the electrode grid.

The presently disclosed embodiments are directed to improvements in existing electrode grid technology.

### SUMMARY

In one aspect, the present disclosure is directed to a method for manufacturing an electrode grid. The method may include forming a series of channels within an active material retaining segment and providing the active material retaining segment to a mold. The method may also include providing a molten conductive material to the mold, causing the molten conductive material to flow into the channels. In addition, the method may include allowing the molten conductive material to solidify, thereby forming an electrode grid comprised of the active material retaining segment and the solidified conductive material.

In another aspect, the present disclosure is directed to an electrode grid for a battery. The electrode grid may include at least one active material retaining segment, the active material retaining segment including one or more channels, wherein the at least one active material retaining segment is formed of at least one of carbon foam and graphite foam. In addition, the electrode grid may include a conductive material deposited within the one or more channels.

In another aspect, the present disclosure is directed to a battery. The battery may include a case, an electrolyte, and an electrode plate. The electrode plate may include two or more active material retaining segments each including a carbon foam core having one or more channels. The electrode plate may also include a conductive material in contact with the two or more active material retaining segments, substantially bonding the two or more active material retaining segments to one another, wherein the conductive material is also deposited within the one or more channels. In addition, the electrode plate may include an active material disposed on the two or more active material retaining segments.

### BRIEF DESCRIPTION OF THE DRAWINGS

The accompanying drawings, which are incorporated in and constitute a part of this specification, show certain aspects of the present invention and, together with the description, help explain some of the principles associated with the invention. In the drawings:

FIG. 1 shows an exemplary battery having a cutaway portion showing electrode plates inside the battery;

FIG. 2 shows an electrode plate according to an exemplary disclosed embodiment;

FIG. 3 is a cross-sectional view of the electrode plate shown in FIG. 2, taken at line 3-3 in FIG. 2;

FIG. 4 shows a cross-sectional view of an alternative electrode plate embodiment;

FIG. 5 is a diagrammatic illustration of an electrode plate having reinforcement features according to an exemplary disclosed embodiment;

FIG. 6 shows an electrode plate according to an alternative embodiment;

FIG. 7A shows an electrode plate according to another alternative embodiment;

FIG. 7B shows a cross-sectional view taken at line 7B-7B in FIG. 7A.

FIG. 8 shows a cross-sectional view of an alternative electrode plate embodiment;

FIG. 9A shows a cross-sectional view of an embodiment of an electrode grid including two active material retaining segments bonded together by conductive material;

FIG. 9B shows a cross-sectional view of an alternative embodiment of an electrode grid including two active material retaining segments bonded together by conductive material;

FIGS. 10A and 10B show a mold for forming an electrode grid according to exemplary disclosed embodiments;

FIG. 10C shows an enlarged view of an area designated 10C about a pin within the mold shown in FIG. 10B;

FIG. 10D shows an enlarged view of an upper left corner of the half of the mold shown in FIG. 10B;

FIG. 11 shows an active material retaining segment according to an exemplary disclosed embodiment; and

FIG. 12 shows a holding pin configured to engage an active material retaining segment during molding.

### DESCRIPTION

Reference will now be made in detail to the drawings. Wherever possible, the same reference numbers will be used throughout the drawings to refer to the same or like parts.

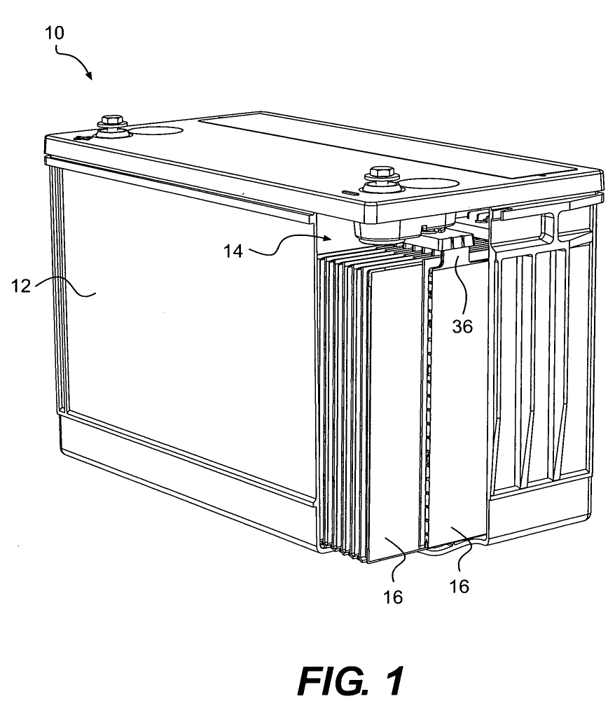

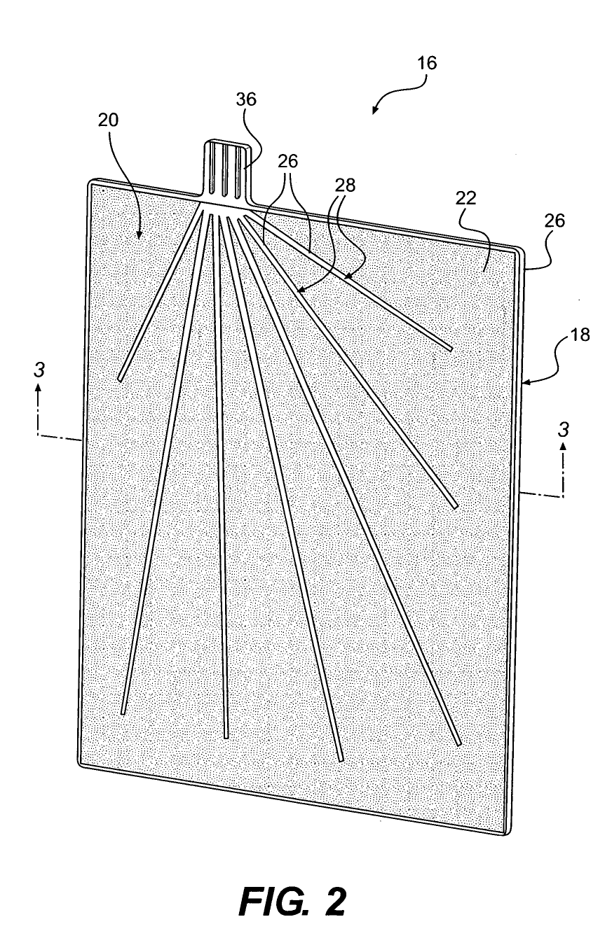

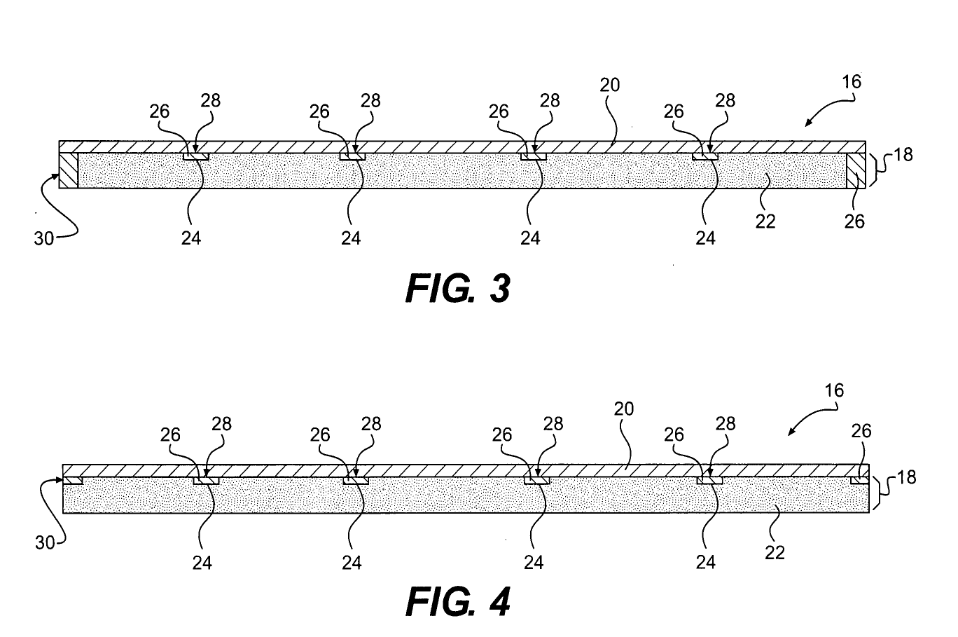

FIG. 1 shows an exemplary disclosed battery 10. Battery 10 may include a case 12, at least one electrode plate 16, and an electrolyte 14 disposed within case 12. FIG. 2 shows an exemplary embodiment of electrode plate 16, which will be discussed in further detail below. FIG. 3 is a cross-sectional view taken at line 3-3 in FIG. 2. Electrode plate 16 may include an electrode grid 18 and an active material 20 disposed on the surface of electrode grid 18. Electrode plate 16 may be a positive or negative electrode plate.

Battery 10 may have any suitable chemistry. For example, battery 10 may be a lead-acid battery. Any suitable acid may be used for electrolyte 14. In some embodiments, electrolyte 14 may include an aqueous electrolytic solution within which the positive and negative plates may be immersed. The composition of electrolyte 14 may be chosen to correspond with a particular battery chemistry. For example, in some embodiments, wherein battery 10 may be a lead-acid battery, electrolyte 14 may include sulfuric acid mixed with water. Alternatively, batteries of other chemistries may include other electrolytes.

In another embodiment, electrolyte 14 may include a gel. For example, the gel electrolyte may include a silica-based gel. To prepare the silica gel, silica particles having a primary particle size of less than about 1 micron may be added to an aqueous electrolytic solution as described above. In certain embodiments, silica particles may be added to a solution of sulfuric acid and distilled water in an amount of about 1% to about 8% by weight to form a gel electrolyte. This gel electrolyte can be added to battery 10 such that the gel at least partially fills a volume between the positive and negative plate or plates of battery 10.

Active material 20 may include any compound suitable for use with the particular chemistry of the battery and the polarity of the electrode. For example, for lead-acid batteries, active material 20 may include lead dioxide for positive electrode embodiments or lead for negative electrode embodiments.

Electrode grid 18 may include at least one active material retaining segment 22. In some embodiments, one or more active material retaining segments 22 may be formed of a carbon foam or graphite foam core. Active material 20 may be applied to active material retaining segment 22 in the form of a paste. In embodiments that include multiple carbon foam or graphite foam active material retaining segments 22, active material 20 may permeate the pores of the carbon foam or graphite foam, and may solidify, spanning the junction between segments 22, thus uniting the segments 22.

In other embodiments, active material retaining segments 22 may include a polymer or polymer composite material. For example, active material retaining segments 22 may be formed of a polymer such as polyolefin, ABS, polyester, polyvinyl ester, styrene, rubber, any other suitable polymer, or combinations of these materials. In some embodiments, active material retaining segments 22 may include a polymer composite, which may include a matrix of the polymers mentioned above and may further include one or more fillers such as carbon, ceramic, metal, or other suitable materials, or combinations of these materials. The polymers may provide a lightweight active material retaining segment, while the fillers may enhance other properties of the segment, such as strength, durability, thermal conductivity, electrical conductivity, etc.

In some embodiments, active material retaining segments 22 may include interstices, such as one or more channels 24. Channels 24 may be formed in any suitable shape and may be located in any suitable position on active material retaining segments 22. Embodiments of electrode grid 18 formed with various configurations of channels 24 are discussed in more detail below.

Electrode grid 18 may also include a conductive material 26 in contact with active material retaining segments 22. Conductive material 26 may be deposited within channels 24, thus forming conductive strands (e.g., wires) 28, as represented in FIGS. 2, 3, and 4 for example. Any suitable conductive material may be used to form electrode grid 18. In some embodiments, such as for lead-acid batteries, conductive material 26 may include lead. In other embodiments, conductive material 26 may include a lead composition, such as a lead alloy. Other metals and electrically conductive materials, especially those with resistance to the chemical environment found within a battery, may be used to form conductive material 26.

Conductive material 26 may be configured in any suitable arrangement for making electrical contact with active material retaining segments 22. In one embodiment, conductive strands 28 may be configured to radiate outwardly from a conductive tab 36, as shown in FIG. 2. Although shown to have various straight configurations, conductive strands 28 may have any suitable configuration, e.g., curved. Suitable shapes for conductive strands 28 may be determined, at least in part, by the manufacturing process. For example, channels 24 may be formed in any suitable shape that allows flow of molten conductive material 26 into the full length of each channel 24. Accordingly, substantially straight or gently curved channels 24 may facilitate the manufacturing of electrode grids according to the embodiments disclosed herein.

Additionally, in some embodiments, conductive material 26 may be formed as a border 30 around a perimeter or outer edge of active material retaining segment 22. Border 30 of conductive material 26 may decrease the flexibility of active material retaining segment 22, protect segment 22, which may be formed of a brittle carbon foam or graphite foam, and/or further enhance the collection of electrical current from electrode grid 18. In one embodiment, conductive material 26 may be formed as a border that extends across the entire thickness of active material retaining segment 22 over substantially the full perimeter of active material retaining segment 22, as shown in FIGS. 2 and 3. Alternatively, border 30 may be configured to extend only partly across the thickness of active material retaining segment 22, as shown in FIG. 4.

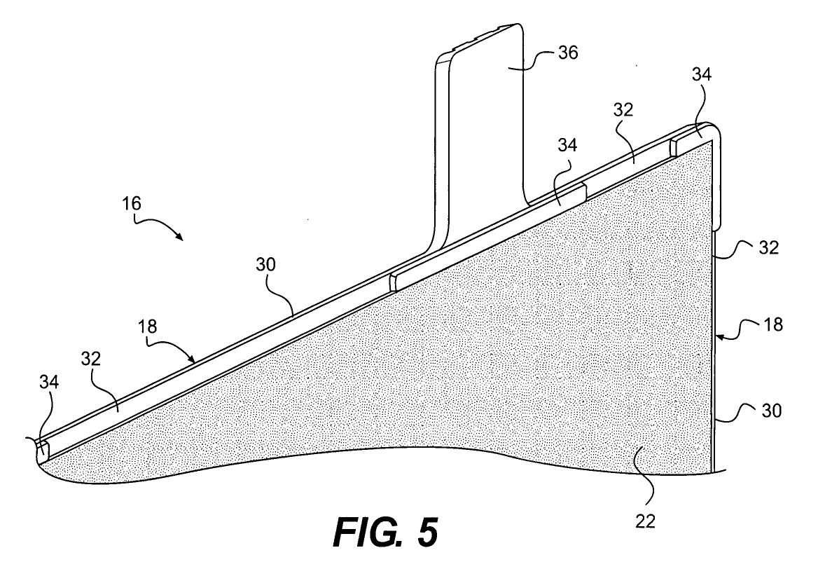

Additionally, as shown in FIG. 5, in some embodiments, border 30 may extend partially across the thickness of active material retaining segment 22 in some areas, and completely across the thickness of active material retaining segment 22 in other areas. For example, border 30 may include thinner sections 32 and thicker sections 34. In some embodiments, thicker sections 34 may be disposed at locations such as the corners and/or near a tab 36, as shown in FIG. 5, to provide reinforcement. The thickness of border 30, and the extent to which border 30 may include thicker or thinner sections may be based on a number of considerations, such as weight, electrical conductivity, structural support, resistance to physical damage, etc.

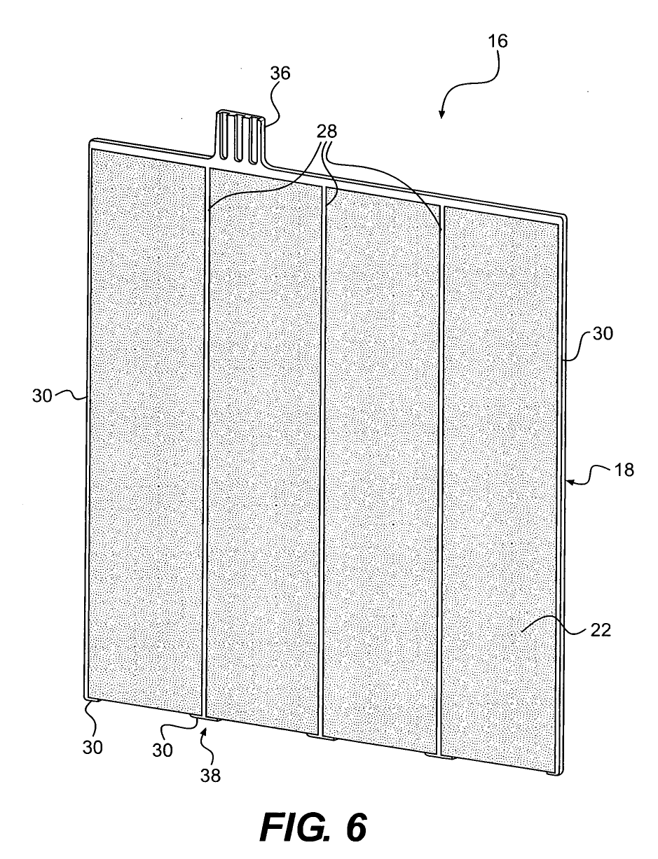

In some embodiments, border 30 may be discontinuous, extending only partially around the perimeter of active material retaining segment 22, as shown in FIG. 6. For example, FIG. 6 shows an exemplary embodiment of electrode grid 18, having vertically oriented, parallel conductive strands 28. In embodiments, conductive strands 28 may be configured to intersect border 30, forming T-shaped junctions 38. The embodiment shown in FIG. 6 may include a single active material retaining segment 22 with conductive strands 28 disposed in channels formed in segment 22. Alternatively, the embodiment shown in FIG. 6 may include multiple active material retaining segments 22 separated by conductive strands 28.

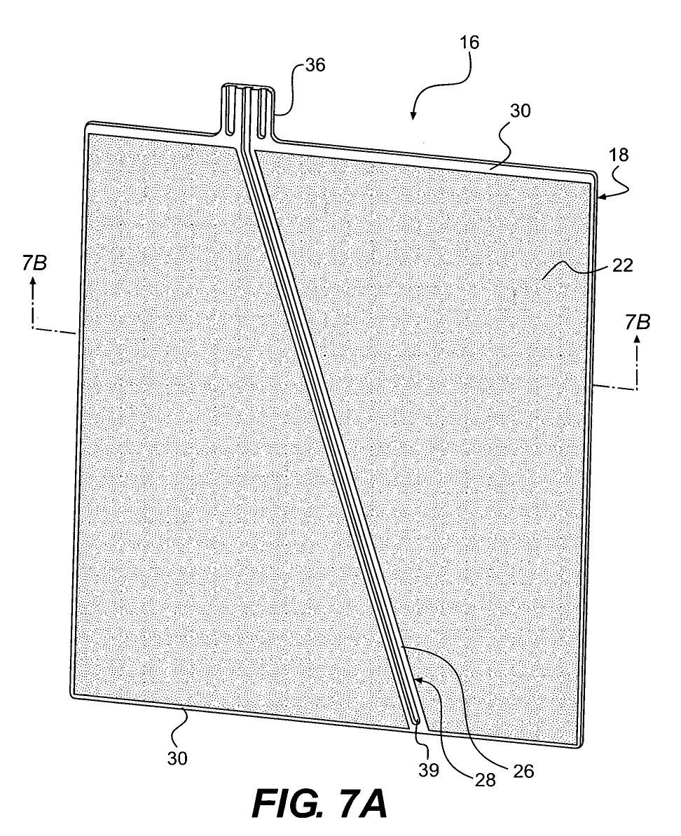

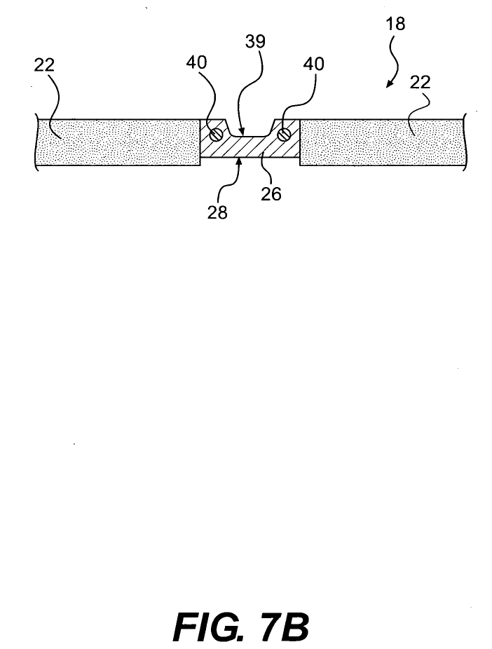

FIG. 7A shows another embodiment of electrode grid 18. As shown in FIG. 7A, electrode grid 18 may include two or more active material retaining segments 22. In this embodiment, active material retaining segments 22 may be bonded edge-to-edge by conductive strand 28. As shown in FIG. 7A, electrode grid 18 may include a single conductive strand 28, formed of conductive material 26, which may be in contact with, and substantially bond, active material retaining segments 22 to one another. Conductive strand 28 may extend diagonally from an electrically conductive tab 36 on one side of electrode grid 18 to an opposite side of electrode grid 18. In order to maximize the surface area of conductive material, conductive strand 28 may extend diagonally across electrode grid 18, enabling conductive strand 28 to be longer than if it were disposed transversely or longitudinally.

In this embodiment, border 30 may have any of the configurations described above, and may extend around the perimeter of electrode grid 18. Rather than forming conductive strand 28 to stop short of border 30 at the bottom of electrode grid 18, as in other embodiments (see, e.g., FIG. 2), conductive strand 28 may connect with border 30, not only at the top, at or near tab 36, but also at the bottom of electrode grid 18, as shown in FIG. 7A. Forming such an embodiment from two completely separate active material retaining segments 22 may facilitate manufacturing of electrode grid 18.

As shown in FIGS. 7A and 7B, conductive strand 28 may include a groove 39 formed therein. Groove 39 may be molded into conductive strand 28 in order to improve strength and stiffness, and also to reduce weight, by using less of conductive material 26. FIG. 7B shows a cross section of the embodiment of conductive strand 28 shown in FIG. 7A. In some embodiments, conductive strand 28 may include one or more wire forms 40 embedded in conductive material 26, as shown in FIG. 7B. As an alternative, conductive strand 28 may be provided without an embedded wire form.

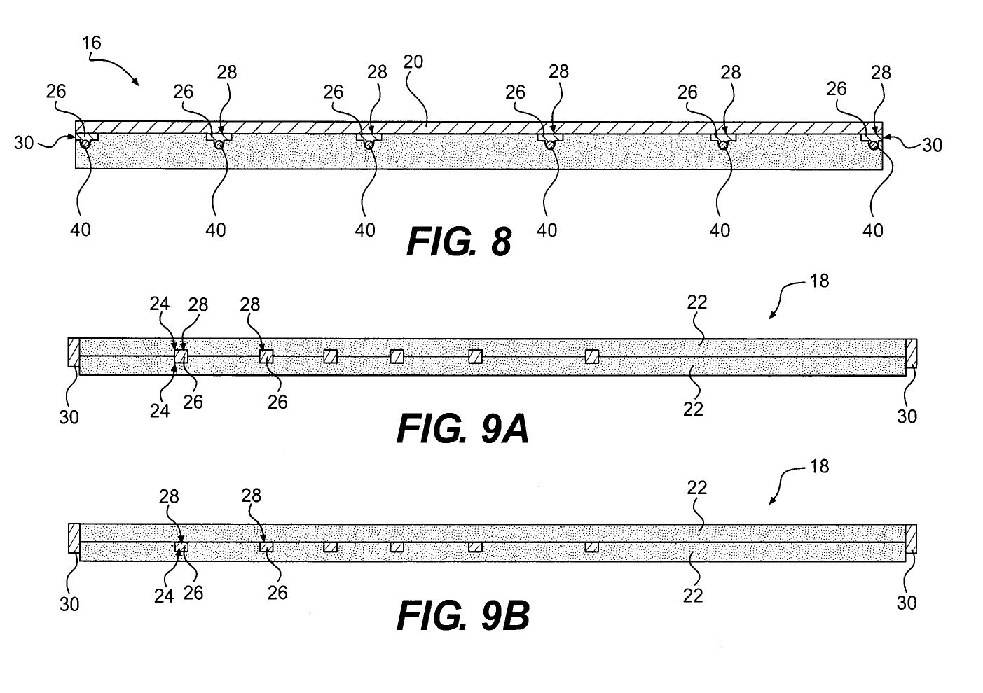

FIG. 8 shows a cross-sectional view of an alternative embodiment of electrode plate 16, wherein a wire form may be crushed into active material retaining segment 22. For example, as shown in FIG. 8, at least one wire form 40 may be crushed into active material retaining segment 22 at the bottom of channels 24 and/or about a perimeter of active material retaining segment 22. As shown in FIG. 8, wire forms 40 may be covered with conductive material 26. In some embodiments, wire form 40 may be completely embedded in conductive material 26. (See FIG. 7B.) Wire form 40 may include a pre-formed wire of conductive material, such as a copper (or copper alloy, e.g., beryllium copper) strand. Alternatively, wire form 40 may be formed of any material having suitable properties, i.e., high conductivity, suitable ductility, and, for embodiments wherein wire form 40 may not be completely embedded in conductive material 26, resistance to the chemical environment within battery 10.

In some embodiments, wire form 40 may include a conductive plastic or conductive composite material. For example, wire form 40 may include a matrix of polyolefin, ABS, polyester, polyvinyl ester, styrene, or rubber, and may be filled or laminated with carbon, graphite, or metal structures. In some embodiments, the filler may include particles, flakes, or fibers. While the plastic matrix may provide light weight, and resistance to corrosion, the filler or laminate may provide enhanced thermal and/or electrical properties, which may facilitate flow or processing of the molten conductive material during molding of electrode grid 18.

FIG. 9A shows a cross-section of another alternative embodiment of electrode grid 18. As shown in FIG. 9A, two or more active material retaining segments 22 may be substantially bonded face to face. Such bonding may be effectuated by conductive material 26, which may be molded between segments 22, e.g., in the form of conductive strands 28, which may be formed in channels 24 in segments 22. As shown in FIG. 9A, channels 24 may be located in each segment 22, thus resulting in conductive strands 28 that extend into both segments 22. Alternatively, as shown in FIG. 9B, channels 24 may be provided in only one of segments 22.

Whether an embodiment like that of FIG. 9A is selected or one like FIG. 9B may depend on the desired size of channels 24. For example, if deeper channels 24 are desired, it may be appropriate to use a configuration such as shown in FIG. 9A, so that no particular segment has too much material removed. On the other hand, if more shallow channels 24 are desired, it may be appropriate to use a configuration such as shown in FIG. 9B, so that channels 24 have to be created in only one of segments 22, thus providing manufacturing advantages.

The features of electrode grid 18 discussed above may be configured in a number of different ways. For example, channels 24, conductive strands 28, and wire form 40, may be arranged/disposed on electrode grid 18 in a variety of configurations and locations. In some embodiments, these features may be disposed on only a single side of active material retaining segment 22. In other embodiments, these features may be disposed on both sides of active material retaining segment 22. In still other embodiments, these features may be disposed between active material retaining segments 22. (See, e.g., FIGS. 9A and 9B.) Providing conductive strands 28 between active material retaining segments may be desirable to increase the amount of surface area to which active material may be applied, thus increasing the electrode plate's capacity to produce current.

In addition, the features described above may also be combined in a number of different ways. For example, in some embodiments, electrode grid 18 may include channels 24 and conductive strands 28 within channels 24, but not wire form 40 within channels 24. In other embodiments, all three features may be present. In addition, wire form 40 may be located in a central region of active material retaining segments 22 and/or about the perimeter of active material retaining segments 22.

### INDUSTRIAL APPLICABILITY

The disclosed electrode grid may be applicable for use in batteries using a number of different chemical processes and which may be suitable for use in any of a number of different applications. For example, the disclosed electrode grid may be configured for use in a lead-acid battery. Such batteries have a variety of uses, such as in automobiles, construction equipment, etc. The disclosed concepts may be applicable to both positive and negative electrode grids.

Each of the different embodiments of electrode grid disclosed herein may be more or less suitable for certain applications, and thus, the features described herein may be implemented and combined to achieve an electrode grid having properties that are advantageous for an intended application. For example, grids intended to be used in a battery that will be used to supply significant amounts of current (e.g., a battery used to start a vehicle), may employ more of conductive material 26 in order to conduct more current from active material 20 to the terminals of battery 10. In other embodiments, weight may be more of a concern and, therefore, less of conductive material 26 may be used. For some applications, strength, stiffness, and or durability may be of particular concern. For such applications, electrode grid 18 may be provided with more of conductive material 26 and/or conductive material 26 may be strategically placed for reinforcement of electrode grid 18, e.g., near tab 36 and/or at the corners of active material retaining segment 22.

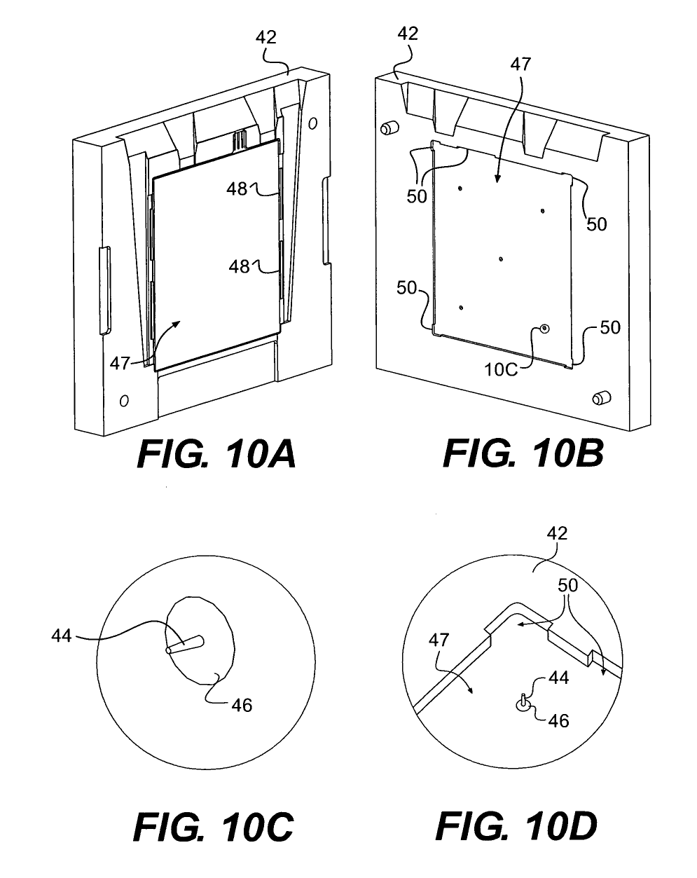

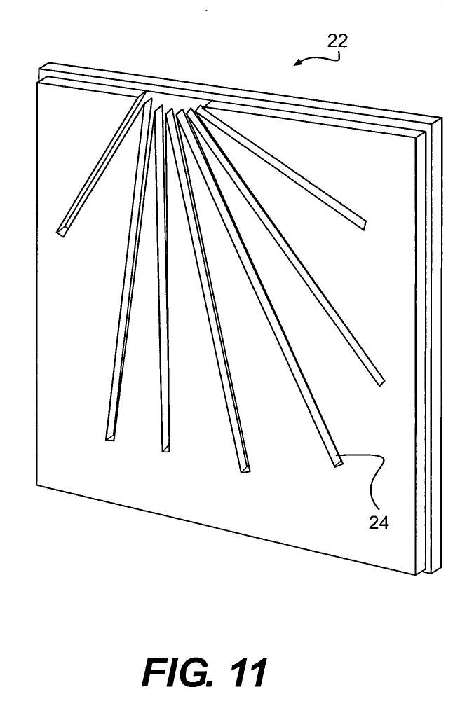

In some embodiments consistent with the present disclosure, a molding technique (e.g., book molding, injection molding, etc.) may be utilized to form an electrode grid structure according to the embodiments discussed above. An exemplary mold 42 and components thereof are shown in FIGS. 10A through 10D. FIG. 10A shows one half of mold 42 and FIG. 10B shows the other half of mold 42.

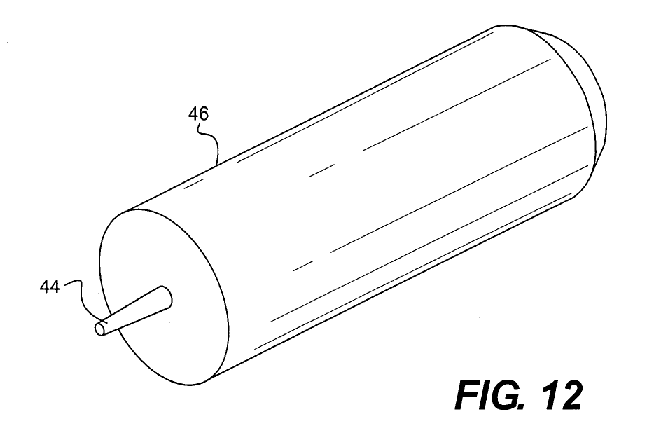

Active material retaining segment 22, an exemplary embodiment of which is shown in FIG. 11, may be added to mold 42, for example by fixing or simply placing segment 22 into either half of mold 42. The halves of mold 42 may be closed around segment 22. Mold 42 may include one or more features for holding active material retaining segments 22. For example, as shown in FIGS. 10B and 10C, mold 42 may include one or more pins 44. Pins 44 may pierce active material retaining segment material, such as carbon foam, and thus hold the segment in place, yet allowing the segment to be easily removed from mold 42. As shown in FIG. 12, pin 44 may extend from a peg 46, which may be inserted into mold 42. Each peg 46 may be removable from mold 42, to facilitate replacement of pins 44. Pins 44 may be provided on either or both halves of mold 42.

In addition, as shown in FIGS. 10A and 10B, either or both halves of mold 42 may include a pocket 47. Pocket 47 may include a recess in mold 42, shaped to contain one or more of active material retaining segments 22. Pocket 47 may be defined, at least in part, by one or more protruding members 48, as shown in FIG. 10A, which may be configured to hold active material retaining segments 22 in the desired orientation and location for the molding process. In addition, mold 42 may include one or more recesses 50, as shown in FIG. 10B, that may be configured to be filled with molten conductive material during the molding process. FIG. 10D is an enlarged view of the top left corner of the embodiment of pocket 47 shown in FIG. 10B. As shown in FIGS. 10B and 10D, in certain embodiments, recesses 50 may be extensions of pocket 47.

In some embodiments, protruding members 48 in mold 42 may provide electrode grid 18 with thinner sections 32 of border 30, as shown in FIG. 5, by occupying some of the space immediately surrounding active material retaining segment 22 while in mold 42. In some embodiments, portions of mold 42 adjacent the perimeter of segment 22 may extend completely across the thickness of segment 22 in order to produce a portion of an electrode grid without any border of conductive material. Recesses 50 may provide electrode grid 18 with thicker sections 34 of border 30, as also shown in FIG. 5, by creating additional space about the perimeter of active material retaining segment 22 for molten conductive material to flow.

Once active material retaining segment 22 has been placed into mold 42, a molten conductive material (e.g., lead or lead alloy) may be provided to mold 42. The molten conductive material may flow into mold 42, flowing around and/or between active material retaining segments 22. As the molten material cools and solidifies, the molten material and active material retaining segments 22 may bond together forming an electrode grid. The electrode grid may then be coated with active material to form an electrode plate, which may be utilized within a battery.

In some embodiments, a forming mold, stamp, or die may be used to crush a series of channels 24 into carbon foam and/or graphite foam segments 22 prior to placing segments 22 in mold 42. In other embodiments, channels 24 may be cut out by machining. When molten conductive material is added to mold 42 containing segments 22, the molten conductive material may flow into channels 24, forming a series of conductive strands. Having conductive material 26 deposited within channels 24 may create additional conductive surface area within an electrode which may lead to increased conductivity.

A perimeter molding technique may be used to produce a border 30 of conductive material 26 on one or more segments 22. For example, a perimeter wire form, consisting of a strand of solidified conductive material, may be “crushed” into active material retaining segment 22. The combination may then be inserted into mold 42 and molten conductive material may be added. An exemplary perimeter molding technique, may include forming a copper strand into a desired wire form. The copper wire form 40 may then be pressed/crushed into a graphite foam active material retaining segment 22 and placed in mold 42. Molten lead may be added to mold 42 and allowed to flow around active material retaining segments 22 and into interstices, including channels 24, thereby covering copper wire form 40, which has been crushed into one or more of segments 22. Upon hardening of the molten lead, the copper, graphite foam, and lead may form an electrode grid of a desired strength and conductivity.

Active material retaining segments 22 and/or mold 42 may include one or more features to prolong the molten state of the molten conductive material by enabling better flow in and through the mold by increasing flow time of the molten conductive material before cooling and solidifying. In some cases, materials with high thermal conductivity (e.g., copper, or copper alloy, such as beryllium copper) may be provided with active material retaining segments 22 and/or within mold 42. For example, copper wire form 40 may provide for better flow of molten conductive material through channels 24 by heating quickly and thereby slowing the cooling of the molten conductive material.

In some embodiments, pressure ranging from about 50 psi to about 100 psi may be applied to the molten conductive material once within mold 42. This may allow the molten material to fill mold 42 and any recesses of mold 42 not occupied by segment 22 more quickly by prolonging the molten state. This may also force the molten conductive material into interstices, such as channels 24 in active material retaining segments 22.

Additional benefits from systems and methods of the present disclosure may include an increase in electrically conductive points formed by the molten lead flowing into pores associated with carbon foam and/or graphite foam segments. This increase in surface area may allow electrical current to travel multiple paths associated with the electrode grid.

It will be apparent to those having ordinary skill in the art that various modifications and variations can be made to the disclosed insert molded electrode grid without departing from the scope of the disclosed embodiments. Other embodiments of the disclosed grid will be apparent to those having ordinary skill in the art from consideration of the specification and practice of the concepts disclosed herein. It is intended that the specification and examples be considered as exemplary only, with a true scope of the disclosed device and method being indicated by the following claims and their equivalents.

I claim:

1. A method for manufacturing an electrode grid, comprising:
forming a series of channels within an active material retaining segment;
providing the active material retaining segment to a mold;
providing a molten conductive material to the mold, causing the molten conductive material to flow into the channels; and
allowing the molten conductive material to solidify, thereby forming an electrode grid comprised of the active material retaining segment and the solidified conductive material.

2. The method of claim 1, wherein a pressure ranging from 50 psi to 150 psi is applied within the mold after providing the molten conductive material.

3. The method of claim 1, further including coating the electrode grid with an active material to form an electrode plate.

4. The method of claim 1, wherein the active material retaining segment includes a polymer or a polymer composite.

5. The method of claim 1, wherein the active material retaining segment includes carbon foam or graphite foam.

6. The method of claim 5, wherein forming the series of channels includes machining or using a forming mold to crush the series of channels into the active material retaining segment.

7. The method of claim 1, further including crushing a wire form into the active material retaining segment prior to providing the molten conductive material to the mold.

8. The method of claim 1, further including incorporating one or more materials with high thermal conductivity into the mold to thereby increase flow time for the molten conductive material before the conductive material cools and solidifies.

9. An electrode grid for a battery, comprising:
at least one active material retaining segment, the active material retaining segment including one or more channels;
wherein the at least one active material retaining segment is formed of at least one of carbon foam and graphite foam; and
a conductive material deposited within the one or more channels.

10. The electrode grid of claim 9, wherein the conductive material includes lead or a lead composition.

11. The electrode grid of claim 9, further including a wire form crushed into the at least one active material retaining segment and covered by the conductive material.

12. The electrode grid of claim 11, wherein the wire form includes a plastic or composite material.

13. The electrode grid of claim 9, wherein the conductive material forms a border at least partially surrounding a perimeter of the at least one active material retaining segment, and extending at least partially across the thickness of the at least one active material retaining segment.

14. The electrode grid of claim 13, wherein at least a portion of the border extends completely across the thickness of the at least one active material retaining segment.

15. The electrode grid of claim 9, wherein the one or more channels includes a plurality of channels radiating outwardly from a conductive tab of the electrode grid.

16. The electrode grid of claim 9, wherein the conductive material forms a conductive strand, the conductive strand including a groove formed therein.

17. An electrode plate including the electrode grid of claim 9, and further including:
one or more additional active material retaining segments;
wherein the conductive material is in contact with two or more of the active material retaining segments, substantially bonding the two or more active material retaining segments to one another; and
an active material disposed on the two or more active material retaining segments.

18. A battery, comprising:
a case;
an electrolyte; and
an electrode plate comprising:
two or more active material retaining segments each including a carbon foam core having one or more channels;
a conductive material in contact with the two or more active material retaining segments, substantially bonding the two or more active material retaining segments to one another, wherein the conductive material is also deposited within the one or more channels; and
an active material disposed on the two or more active material retaining segments.

19. The battery of claim 18, further including an electrically conductive wire form crushed into at least one of the two or more active material retaining segments about a perimeter thereof and covered by the conductive material.

20. The battery of claim 19, wherein the electrically conductive wire form includes a conductive plastic or conductive composite material.
